(19) United States
(12) Patent Application Publication
(10) Pub. No.: US 2020/0062983 A1
(43) Pub. Date: Feb. 27, 2020

(54) PRINTING INK

(71) Applicant: Fujifilm Speciality Ink Systems Limited, Broadstairs Kent (GB)

(72) Inventors: Angelique Runacre, Broadstairs Kent (GB); Andrew Phillips, Broadstairs Kent (GB)

(21) Appl. No.: 16/607,334

(22) PCT Filed: Apr. 24, 2018
(86) PCT No.: PCT/GB2018/051063

§ 371 Date: Oct. 22, 2019

(30) Foreign Application Priority Data
Apr. 24, 2017 (GB) 1706455.1
Dec. 21, 2017 (GB) 1721642.5

(51) Int. Cl. C09D 11/38; C09D 11/322; C09D 11/107; C09D 11/101; C09D 11/037; B41M 5/00; B41J 11/00; B41M 7/00

(52) U.S. Cl. CPC C09D 11/38; C09D 11/322; C09D 11/107; B41M 7/0081; C09D 11/037; B41M 5/0023; B41J 11/002; C09D 11/101

(57) ABSTRACT

The present invention provides an inkjet ink comprising: NVC or NVMO; PEA; 4-methoxyphenol; and a thioxanthone photoinitiator. The present invention also relates to a method of inkjet printing inks of the invention. The present invention further provides the use of 4-methoxyphenol for reducing colour shift in inkjet inks.

The present invention relates to a printing ink and in particular, an inkjet ink which has a reduced colour shift. The present invention also relates to a method of printing said ink.

In inkjet printing, minute droplets of black, white or coloured ink are ejected in a controlled manner from one or more reservoirs or printing heads through narrow nozzles on to a substrate which is moving relative to the reservoirs. The ejected ink forms an image on the substrate. For high-speed printing, the inks must flow rapidly from the printing heads, and, to ensure that this happens, they must have, in use, a low viscosity, typically below 100 mPas at 25° C. (although in most applications the viscosity should be below 50 mPas, and often below 25 mPas). Typically, when ejected through the nozzles, the ink has a viscosity of less than 25 mPas, preferably 5-15 mPas and ideally 7-12 mPas at the jetting temperature, which is often elevated to about 40-50° C. (the ink might have a much higher viscosity at ambient temperature). The inks must also be resistant to drying or crusting in the reservoirs or nozzles. For these reasons, inkjet inks for application at or near ambient temperatures are commonly formulated to contain a large proportion of a mobile liquid vehicle or solvent.

In one common type of inkjet ink, this liquid is water—see for example the paper by Henry R. Kang in the Journal of Imaging Science, 35(3), pp. 179-188 (1991). In those systems, great effort must be made to ensure the inks do not dry in the head due to water evaporation. In another common type, the liquid is a low-boiling solvent or mixture of solvents—see, for example, EP 0 314 403 and EP 0 424 714. Unfortunately, inkjet inks that include a large proportion of water or solvent cannot be handled after printing until the inks have dried, either by evaporation of the solvent or its absorption into the substrate. This drying process is often slow and in many cases (for example, when printing on to a heat-sensitive substrate such as paper) cannot be accelerated.

Another type of inkjet ink contains radiation-curable material, such as radiation-curable monomers, which polymerise by irradiation with actinic radiation, commonly with ultraviolet light, in the presence of a photoinitiator. This type of ink has the advantage that it is not necessary to evaporate the liquid phase to dry the print; instead the print is exposed to radiation to cure or harden it, a process which is more rapid than evaporation of solvent at moderate temperatures. Amongst other considerations, monomers to include in radiation-curable inks are selected based on the film-forming properties that they confer to the ink. However, such monomers may cause problems with colour shift of the inks post-cure and in particular, problems with yellow shift of the inks post-cure. This is particularly problematic in white and colourless inks where yellowing is most visible. Colour shift and yellow shift is discussed hereinbelow. One way to overcome this problem is to minimise the amount of any problematic monomers that are present but as a result, the film-forming properties of the inks suffer.

There are a number of sources of actinic radiation which are commonly used to cure inkjet inks which contain radiation-curable material. The most common source of radiation is a UV source. UV sources include mercury discharge lamps, fluorescent tubes, light emitting diodes (LEDs), flash lamps and combinations thereof.

Mercury discharge lamps, fluorescent tubes and flash lamps are traditionally used as the radiation source as they have an impressive UV output performance. However, these radiation sources have several drawbacks in their operational characteristics, and LED UV light sources are an attractive alternative. In particular, when compared to, for example mercury discharge lamps (the most common UV light source used to cure inkjet inks), LEDs offer significant cost reduction, longer maintenance intervals, higher energy efficiency and are an environmentally friendlier solution. However, there are a number of challenges when utilising LED UV light sources as the radiation source.

When LEDs are used, it is necessary to use an array of multiple LEDs in order to generate enough power to provide thorough curing of the ink. In fact, even with an array of multiple LEDs, inks which are cured by LEDs are prone to poor surface cure owing to the presence of oxygen in the atmosphere adjacent to the ink surface, and the spectral output of LEDs. Compared to conventional mercury lamp UV sources, LEDs have a narrow spectral output. The UV output of LED lamps is essentially monochromatic and most commercial devices operate at 385, 395 or 405 nm. LEDs emit radiation in the UVA region having a long wavelength over a narrow range of wavelengths, which although suitable for depth cure, provides a particular challenge for effective surface cure in normal atmospheric conditions.

Poor surface cure can be reduced in a number of ways. First, it can be overcome by blanketing the irradiated area with an inert gas such as nitrogen during the cure process but this adds considerably to the complexity and cost of the printer. Secondly, it can be overcome by working the LEDs at high power, providing more energy to react with the photoinitiators and oxygen, or the total amount of photoinitiators may be increased, thus allowing more radicals to be generated. However, working the LEDs at high power generates heat, which must be removed, and both approaches add to the cost and complexity of the process—regard must be had to limitations on the media range, power consumption, ink viscosity and ink stability. Thirdly, a blend of photoinitiators may be used, including photoinitiators that function throughout the ink resulting in through cure and those that work at the surface of the ink, to obtain adequate surface cure. For example, a type II photoinitiator such as ITX (and hydrogen donating species) in conjunction with type I photoinitiators such as phosphine oxides may be used. Reduced oxygen inhibition has been reported using type II photoinitiators owing to the presence of hydrogen donors which can decrease the concentration of molecular oxygen or react with generated peroxy radicals to reinitiate the polymerisation reaction (see the paper entitled “Strategies to Reduce Oxygen Inhibition in Photoinduced Polymerization” by Samuel Clark Ligon et al in Chemical Reviews, 114(1), pp. 557-589 (2014)). Further, ITX can absorb radiation at longer wavelengths, as well as generating its own radicals, absorbing light and using this energy to sensitise further type I photoinitiators, which act at shorter wavelengths.

However, such blends of photoinitiators in inkjet inks suffer from colour shift post-cure. This is an issue for all UV-curable inkjet inks which comprise a thioxanthone photoinitiator, such as ITX and DETX, but is particularly problematic for LED-curable inkjet inks. In this regard, it is possible to include alternative photoinitiator blends, which do not include a thioxanthone photoinitiator, in UV-curable inkjet inks other than LED-curable inkjet inks, and still achieve adequate surface cure.

However, LED-curable inkjet inks often require a photoinitiator blend comprising a thioxanthone photoinitiator, such as ITX and DETX, which is a photoinitiator that works at the surface of the ink film during curing, in order to achieve adequate surface cure. However, the inclusion of such photoinitiators in inkjet inks increases the problem with colour shift post-cure and particularly yellow shift post-cure. Removal of thioxanthone photoinitiators from the blend of photoinitiators reduces the colour shift post-cure issue but results in poor surface cure in LED-curable inkjet inks.

Colour shift is a known phenomenon in the art. It is when the colour of the ink changes over a period of time, typically measured over 24 hours. The amount of colour change is represented in the art by a so-called delta E (or ΔE)-value on the CIELAB (L*a*b*) colour space system. As a guide, a delta E-value of 1.0 is the minimum colour change detectable by the human eye. A delta E-value influenced by the shift on the b* axis (Δb*) in the yellow quadrant represents a change in the yellowness of the ink. Hence, yellow shift occurs when the colour of the ink shifts towards positive or negative values on the b* axis in the yellow quadrant, and therefore becomes increasingly or decreasingly yellow respectively. A shift towards more positive values on the b* axis in the yellow quadrant is associated with an increase in the yellowness of the ink whereas a shift towards more negative values in the yellow quadrant is associated with a decrease in the yellowness of the ink.

This is problematic for all colours as any change and instability of colour in the ink causes problems. However, this is particularly problematic for cyan inks, which is the opposite colour on the colour spectrum to yellow. Practically, colour shift causes colour profiling issues and is particularly an issue for graphic art printers as it is not acceptable to wait long periods of time for the colour to stabilise in the cured ink image before colour profiling.

By colour shift post-cure, it is meant that colour shift of the ink is only assessed post-cure, i.e. the L*a*b* values are only recorded post-cure, using a spectrophotometer. However, the L*a*b* values of the ink are also changing during and after printing. In this regard, the ink can be thought of as having initial L*a*b* values just before printing, which then change during and after printing, and during and after curing. The first L*a*b* values (L₁*, a₁* and b₁*) are recorded typically within one minute of curing. The second L*a*b* values (L₂*, a₂* and b₂*) are then recorded typically 24 hours later. The formula for calculating delta E is as follows:

ΔE*_{ab}=\sqrt{(L₂*−L₁*)²+(a₂*−a₁*)²+(b₂*−b₁*)²}

In one scenario, yellowing occurs immediately after curing and then fades away during the subsequent 24 hours—the colour of the cured ink images shifts towards negative values on the b* axis in the yellow quadrant. In this scenario, although the mechanism of yellow shift has not been confirmed, without wishing to be bound by theory, the inventors believe the photoinitiator breakdown products, which are generated during photocleaving, have a yellow chromophore, and then over a further period of time these unstable fragments further decompose to reduce the yellow coloration.

As well as being influenced by the choice of photoinitiator, colour shift is also affected by storage temperature of the ink, concentrations of the photoinitiators and the choice of the binder or bulk material such as radiation-curable monomers.

In addition to reducing colour shift post-cure and maintaining the required surface cure, it is of course also necessary to maintain the necessary film-forming properties of the inkjet inks, such as acceptable gamut, gloss, print quality, balance of adhesion, blocking resistance, film toughness, low embrittlement, the correct balance of surface tension, good surface wetting, without excessive ink bleed/spread, in order to produce a good quality image.

There is therefore a need in the art for an inkjet ink which has reduced colour shift post-cure, maintains the required surface cure and the necessary film-forming properties of an inkjet ink.

Accordingly, the present invention provides an inkjet ink comprising: PEA; NVC or NVMO; 4-methoxyphenol; and a thioxanthone photoinitiator.

It has surprisingly been found that the inclusion of 4-methoxyphenol (MEHQ) into an inkjet ink containing a thioxanthone photoinitiator and the specific blend of monomers as claimed achieves a reduction in colour shift and maintains the required surface cure and required film-forming properties.

The inventors have surprisingly found that an inkjet ink that comprises MEHQ has reduced colour shift in the cured ink image and which maintains the required film-forming properties and surface cure of the cured ink image. In particular, it has been found that the presence of MEHQ in an inkjet ink which comprises a thioxanthone photoinitiator and the specific blend of monomers as claimed reduces the level of colour shift in the cured ink image to an acceptable level over 24 hours and maintains surface cure and film-forming properties. It is surprising that the inkjet ink of the invention can achieve such advantages whilst having a thioxanthone photoinitiator and the specific blend of monomers as claimed present.

The inventors have found that the inclusion of MEHQ in inkjet inks comprising a thioxanthone photoinitiator and the specific blend of monomers reduces the colour shift and particularly the yellow shift in the cured ink image to an acceptable level whilst maintaining film-forming properties and surface cure. In this regard, the cured ink image preferably has a delta E absolute value of from 0.0 to 10.0 and preferably from 0.0 to 5.0, over 24 hours. Further, the cured ink image preferably has a Δb* absolute value from 0.0 to 7.0, preferably from 0.0 to 5.0, more preferably from 0.0 to 3.5 and most preferably from 0.0 to 2.0, over 24 hours. An absolute value is the magnitude of a real number without regard to its sign. The first L*a*b* values (L₁*, a₁* and b₁*) are recorded within one minute of curing. The second L*a*b* values (L₂*, a₂* and b₂*) are then recorded 24 hours later. Delta E is calculated using the formula above and Δb* is calculated by subtracting b₁* from b₂*. Delta E values vary with actinic radiation dose, so the delta E values quoted herein are determined at a total dose per unit area defined as the minimum dose per unit area required to achieve a fully cured film, i.e. a tack-free film. A delta E of 10.0 and a Δb* of 7.0 are the largest acceptable absolute values for any application of the present invention. A Δb* of 3.5 is the largest acceptable Δb* absolute value for moderately sensitive applications of the present invention and a Δb* of 2.0 is the largest acceptable Δb* absolute value for important sensitive graphic applications of the present invention. Therefore, the absolute value of Δb* acceptable will depend on the ultimate application of the cured ink image of the present invention. This is in marked contrast to other known inkjet inks comprising a thioxanthone photoinitiator and the specific blend of monomers, which have much higher colour and yellow shifts, and in particular, much more than the acceptable delta E and Δb* absolute values over 24 hours of the present invention when achieving acceptable surface cure.

As discussed above, colour shift is known in the art. It is when the colour of the ink changes over a period of time, typically measured over 24 hours. The larger delta E on the CIELAB (L*a*b*) colour space system, the larger change in colour. Delta E is therefore the measure of how far the colour has changed over time, typically over 24 hours. The lightness, L*, represents the darkest black at L*=0, and the brightest white at L*=100. The colour channels, a* and b*, represents true neutral grey values at a*=0 and b*=0. The red/green opponent colours are represented along the a* axis, with green at negative a* values and red at positive a* values. The yellow/blue opponent colours are represented along the b* axis, with blue at negative b* values and yellow at positive b* values. The total shift along the b* axis is denoted as Δb* and is represented by delta E. Hence, yellow shift occurs when the colour of the ink shifts towards positive or negative values on the b* axis in the yellow quadrant, and therefore becomes increasingly or decreasingly yellow respectively.

Thus, a colour shift occurs when the colour of the ink shifts over 24 hours. The acceptable level of colour shift depends on the colour but a delta E on the CIELAB (L*a*b*) colour space system of at least 1.0 is required to be visible to the human eye and a colour shift is generally acceptable wherein delta E is an absolute value from 0.0 to 10.0 and preferably from 0.0 to 5.0, over 24 hours. A yellow shift occurs when the yellow colour of the ink shifts over 24 hours towards positive or negative values on the b* axis in the yellow quadrant, and therefore becomes increasingly or decreasingly yellow respectively.

The present invention also provides a method of inkjet printing comprising inkjet printing the inkjet ink of the present invention onto a substrate and curing the ink by exposing the printed ink to a UV radiation source.

The present invention further provides the use of MEHQ for reducing colour shift in an inkjet ink.

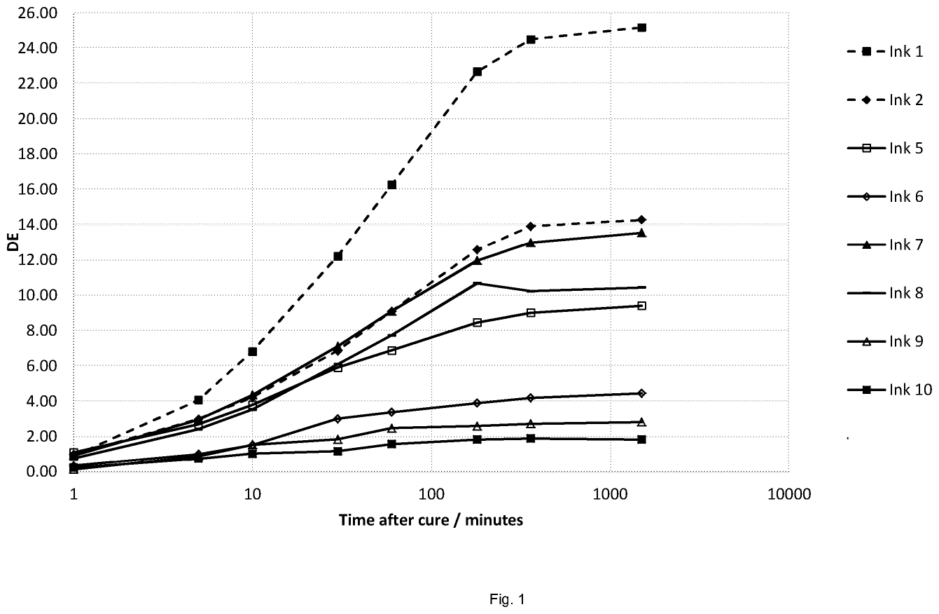

The present invention will now be described with reference to the drawings, in which FIGS. 1-6 show graphs of colour shift over 1,000 minutes for various inks set out in the examples.

The inkjet ink of the present invention comprises 4-methoxyphenol (MEHQ). MEHQ is a known component of inkjet inks. In particular, MEHQ has been included into inkjet inks as an inhibitor and as a stabiliser. A detailed discussion of this component is not therefore required.

The inventors have surprisingly found however that the inclusion of MEHQ into an inkjet ink containing a thioxanthone photoinitiator and the specific blend of monomers as claimed achieves a reduction in colour shift and maintains the required surface cure and required film-forming properties. In particular, it has been found that the presence of MEHQ in an inkjet ink which comprises a thioxanthone photoinitiator and the specific blend of monomers as claimed reduces the level of colour shift in the cured ink image to an acceptable level over 24 hours and maintains surface cure and film-forming properties. It is surprising that the inkjet ink of the invention can achieve such advantages whilst having a thioxanthone photoinitiator and the specific blend of monomers as claimed present.

In a preferred embodiment, the ink of the present invention comprises 0.1 to 5% by weight, preferably 0.1 to 2% by weight of MEHQ, based on the total weight of the ink. The amount of MEHQ required to obtain reduced colour shift will vary depending on the precise formulation of the ink. However, it has been found that this amount is preferable for reduced colour shift, as well as maintaining the required surface cure and film-forming properties.

The inkjet ink of the present invention comprises a thioxanthone photoinitiator. Thioxanthone photoinitiators are well known in the art and include ITX and DETX.

In a preferred embodiment, the ink of the present invention comprises 0.1 to 5% by weight, preferably 0.5 to 4% by weight of thioxanthone photoinitiator, based on the total weight of the ink. The maximum amount of thioxanthone photoinitiator that can be incorporated into an ink and still have acceptable colour shift (when used in conjunction with MEHQ) will vary depending on the precise formulation of the ink. However, it has been found that this amount is preferable for achieving sufficient surface cure of pigmented and colourless inks in conjunction with other photoinitiators for through cure. Significantly, the inclusion of MEHQ allows a higher amount of ITX to be tolerated in the ink when balancing sufficient surface cure with an acceptable colour shift.

In a preferred embodiment, the thioxanthone photoinitiator of the inkjet ink of the present invention comprises ITX or DETX. Colour shift is particularly problematic for inkjet inks containing these particular photoinitiators and the inclusion of MEHQ has surprisingly been found to reduce colour shift in inkjet inks comprising ITX or DETX. In a particularly preferred embodiment, the inkjet ink of the present invention comprises ITX.

In a preferred embodiment, the ink of the present invention comprises 0.1 to 5% by weight, preferably 0.5 to 4% by weight of ITX or DETX, based on the total weight of the ink.

In a preferred embodiment, the ink of the present invention comprises 0.1 to 5% by weight, preferably 0.5 to 4% by weight of ITX, based on the total weight of the ink.

In a particularly preferred embodiment, the molar ratio of MEHQ to the thioxanthone photoinitiator is from 0.5:1 to 10.0:1, more preferably from 0.6:1 to 5.0:1 and most preferably from 1.0:1 to 5.0:1. Preferably, the molar ratio of MEHQ to ITX or DETX is from 0.5:1 to 10.0:1, more preferably from 0.6:1 to 5.0:1 and most preferably from 1.0:1 to 5.0:1. Preferably, the molar ratio of MEHQ to ITX is from 0.5:1 to 10.0:1, more preferably from 0.6:1 to 5.0:1 and most preferably from 1.0:1 to 5.0:1. The colour shift in the cured ink image after 24 hours is surprisingly low when the molar ratio of MEHQ to the thioxanthone photoinitiator is within this range.

The inkjet ink of the present invention is a radiation-curable inkjet ink. It therefore comprises radiation curable-material.

The inkjet ink of the present invention comprises phenoxyethyl acrylate (PEA). PEA is a well-known monofunctional (meth)acrylate monomer and has the following chemical formula:

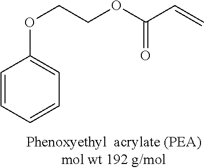

In a preferred embodiment, the ink of the present invention comprises 1-70% by weight, preferably 10 to 30% by weight, more preferably 15 to 25% by weight of PEA, based on the total weight of the ink.

The inkjet ink of the present invention comprises N-vinyl caprolactam (NVC) or N-vinyl-5-methyl-2-oxazolidinone (NVMO). In one embodiment, the inkjet ink of the present invention comprises NVC. In another embodiment, the inkjet ink of the present invention comprises NVMO.

NVC is a well-known N-vinyl amide monomer.

NVMO is an N-vinyl carbamate monomer.

N-Vinyl carbamate monomers are defined by the following functionality:

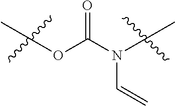 [SMILES: *OC(=O)N(*)C=C]

The synthesis of N-vinyl carbamate monomers is known in the art. For example, vinyl isocyanate, formed by the Curtius rearrangement of acryloyl azide, can be reacted with an alcohol to form N-vinyl carbamates (Phosgenations—A Handbook by L. Cotarca and H. Eckert, John Wiley & Sons, 2003, 4.3.2.8, pages 212-213).

NVMO is an N-vinyl oxazolidinone. N-Vinyl oxazolidinones have the following structure:

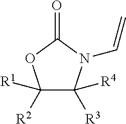

in which R¹ to R⁴ are not limited other than by the constraints imposed by the use in an ink-jet ink, such as viscosity, stability, toxicity etc. The substituents are typically hydrogen, alkyl, cycloalkyl, aryl and combinations thereof, any of which may be interrupted by heteroatoms. Non-limiting examples of substituents commonly used in the art include C₁₋₁₈ alkyl, C₃₋₁₈ cycloalkyl, C₆₋₁₀ aryl and combinations thereof, such as C₆₋₁₀ aryl- or C₃₋₁₈ cycloalkyl-substituted C₁₋₁₈ alkyl, any of which may be interrupted by 1-10 heteroatoms, such as oxygen or nitrogen, with nitrogen further substituted by any of the above described substituents. Preferably, R¹ to R⁴ are independently selected from hydrogen or C₁₋₁₀ alkyl. Further details may be found in WO 2015/022228 and U.S. Pat. No. 4,831,153.

NVMO is available from BASF and has the following structure:

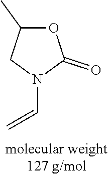

NVMO has the IUPAC name 5-methyl-3-vinyl-1,3-oxazolidin-2-one and CAS number 3395-98-0. NVMO includes the racemate and both enantiomers. In one embodiment, NVMO is a racemate. In another embodiment, NVMO is (R)-5-methyl-3-vinyl-1,3-oxazolidin-2-one. Alternatively, NVMO is (S)-5-methyl-3-vinyl-1,3-oxazolidin-2-one.

In a preferred embodiment, the ink of the present invention comprises 1 to 40% by weight, preferably 10 to 30% by weight, more preferably 10 to 20% by weight of NVC or NVMO, based on the total weight of the ink.

PEA and NVC/NVMO provide the ink with the required film-forming properties such as acceptable gamut, gloss, print quality, balance of adhesion, blocking resistance, film toughness, low embrittlement, the correct balance of surface tension, good surface wetting, without excessive ink bleed/spread, in order to produce a good quality image.

However, NVC and NVMO in particular are known to cause colour shift post-cure and particularly yellow shift post-cure. This is particularly problematic in white and colourless inks where yellowing is most visible. In the present invention, it has surprisingly been found that the inclusion of MEHQ into an inkjet ink containing the specific blend of monomers as claimed including NVC/NVMO achieves a reduction in colour shift and maintains the required film-forming properties.

The inkjet ink of the present invention may include additional radiation-curable material, other than PEA and NVC/NVMO. This additional radiation-curable material is not particularly limited and the formulator is free to include any such additional radiation-curable material in the ink of the present invention to improve the properties or performance of the ink. This additional radiation-curable material can include any radiation-curable material readily available and known in the art in inkjet inks, other than PEA and NVC/NVMO. By “radiation-curable” is meant a material that polymerises and/or crosslinks when exposed to actinic radiation, in the presence of a photoinitiator. By “LED-curable” is meant that the actinic radiation source is an LED.

The amount of additional radiation-curable material is not limited other than by the constraints imposed by the use in an inkjet ink, such as viscosity, stability, toxicity etc. In a preferred embodiment, the ink of the present invention comprises 5 to 90% by weight, more preferably 5 to 60% by weight of additional radiation-curable material, other than PEA and NVC/NVMO, based on the total weight of the ink. In a preferred embodiment, the ink of the present invention comprises a total amount of radiation-curable material, including PEA and NVC/NVMO, of 20 to 90% by weight, more preferably 20 to 80% by weight of radiation-curable material, based on the total weight of the ink.

In a preferred embodiment, the inkjet ink of the present invention comprises additional radiation-curable monomers, other than PEA and NVC/NVMO. As is known in the art, monomers may possess different degrees of functionality, which include mono, di, tri and higher functionality monomers.

In a preferred embodiment, the inkjet ink of the present invention comprises one or more additional monofunctional monomers other than PEA and NVC/NVMO.

In a preferred embodiment, the ink of the present invention comprises 5 to 60% by weight, preferably 10 to 40% by weight of monofunctional monomers, other than PEA and NVC/NVMO, based on the total weight of the ink.

Monofunctional monomers are well known in the art. A radiation-curable monofunctional monomer has one functional group, which takes part in the polymerisation reaction on curing.

The polymerisable groups can be any group that are capable of polymerising upon exposure to radiation and are preferably selected from a (meth)acrylate group and a vinyl ether group.

The substituents of the additional monofunctional monomers are not limited other than by the constraints imposed by the use in an inkjet ink, such as viscosity, stability, toxicity etc. The substituents are typically alkyl, cycloalkyl, aryl and combinations thereof, any of which may be interrupted by heteroatoms. Non-limiting examples of substituents commonly used in the art include C₁₋₁₈ alkyl, C₃₋₁₈ cycloalkyl, C₆₋₁₀ aryl and combinations thereof, such as C₆₋₁₀ aryl- or C₃₋₁₈ cycloalkyl-substituted C₁₋₁₈ alkyl, any of which may be interrupted by 1-10 heteroatoms, such as oxygen or nitrogen, with nitrogen further substituted by any of the above described substituents. The substituents may together also form a cyclic structure.

In a preferred embodiment, the inkjet ink of the present invention comprises one or more additional monofunctional (meth)acrylate monomers, other than PEA, which are well known in the art and are preferably the esters of acrylic acid. A detailed description is therefore not required. Mixtures of (meth)acrylates may also be used.

Preferred examples include cyclic monofunctional (meth)acrylate monomers and acyclic-hydrocarbon monofunctional (meth)acrylate monomers. For example, 2-methyl-2-ethyl-1,3-dioxolane-4-yl)methyl acrylate (Medol-10), cyclic TMP formal acrylate (CTFA), isobornyl acrylate (IBOA), tetrahydrofurfuryl acrylate (THFA), 3,3,5-trimethylcyclohexyl acrylate (TMCHA), 2-(2-ethoxyethoxy)ethyl acrylate, octadecyl acrylate (ODA), tridecyl acrylate (TDA), isodecyl acrylate (IDA), lauryl acrylate and mixtures thereof.

The preferred examples of monofunctional (meth)acrylate monomers have the following chemical structures:

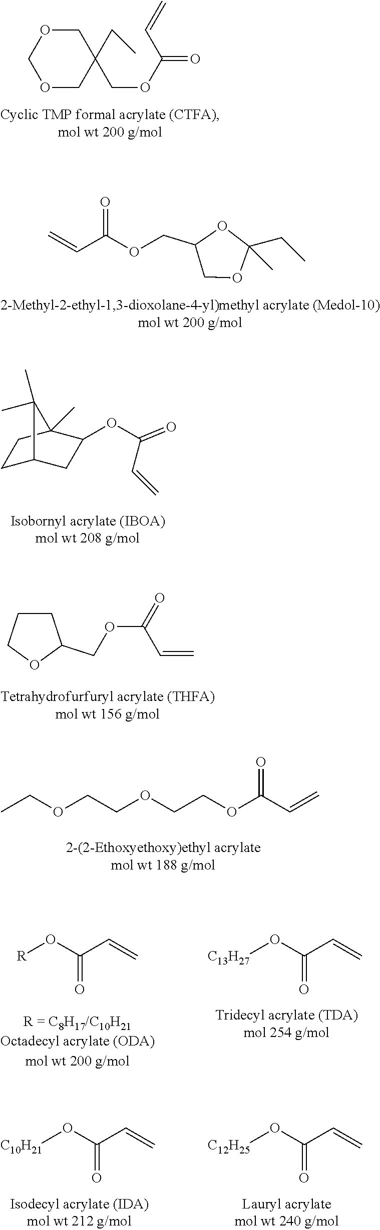

In a preferred embodiment, the inkjet ink of the present invention comprises one or more additional monofunctional (meth)acrylate monomers, other than PEA, selected from IBOA, CTFA and Medol-10.

In a preferred embodiment, the ink of the present invention comprises 5 to 60% by weight, preferably 10 to 30% by weight of additional monofunctional (meth)acrylate monomers, other than PEA, based on the total weight of the ink.

In a preferred embodiment, the inkjet ink of the present invention comprises an N-vinyl amide monomer, other than NVC.

N-Vinyl amide monomers are well-known monomers in the art and a detailed description is therefore not required. N-vinyl amide monomers have a vinyl group attached to the nitrogen atom of an amide which may be further substituted in an analogous manner to the (meth)acrylate monomers. A preferred example is N-vinyl pyrrolidone (NVP).

In a preferred embodiment, the inkjet ink of the present invention comprises an N-vinyl carbamate monomer, other than NVMO.

In a preferred embodiment, the inkjet ink of the present invention comprises an N-acryloyl amine monomer.

Similarly, N-acryloyl amine monomers are also well-known in the art. N-acryloyl amine monomers also have a vinyl group attached to an amide but via the carbonyl carbon atom and again may be further substituted in an analogous manner to the (meth)acrylate monomers. A preferred example is N-acryloylmorpholine (ACMO).

In a preferred embodiment, the total amount of N-vinyl amide monomers, N-acryloyl amine monomers and/or N-vinyl carbamate monomers, including NVC/NVMO, present in the ink of the present invention is 5-30% by weight, more preferably 10-30% by weight, most preferably 10-25% by weight, based on the total weight of the ink.

Preferably, the inkjet ink of the present invention comprises 5-30% by weight of an N-vinyl amide monomer, other than NVC, based on the total weight of the ink. More preferably, the inkjet ink of the present invention comprises 10-30% by weight, most preferably 10-25% by weight of an N-vinyl amide monomer, other than NVC, based on the total weight of the ink.

Preferably, the inkjet ink of the present invention comprises 5-30% by weight of an N-vinyl carbamate monomer, other than NVMO, based on the total weight of the ink. More preferably, the inkjet ink of the present invention comprises 10-30% by weight, most preferably 10-25% by weight of an N-vinyl carbamate monomer, other than NVMO, based on the total weight of the ink.

Preferably, the inkjet ink of the present invention comprises 5-30% by weight of an N-(meth)acryloyl amine monomer, based on the total weight of the ink. More preferably, the inkjet ink of the present invention comprises 10-30% by weight, most preferably 10-25% by weight of an N-(meth)acryloyl amine monomer, based on the total weight of the ink.

In a preferred embodiment, the inkjet ink of the present invention comprises one or more radiation-curable monomers having two or more functional groups. Radiation-curable monomer having two or more functional groups has its standard meaning, i.e. di or higher, that is two or more groups, respectively, which take part in the polymerisation reaction on curing.

In a preferred embodiment, the radiation-curable monomer having two or more functional groups is a di-, tri-, tetra-, penta- or hexa-functional monomer, i.e. the radiation curable monomer has two, three, four, five or six functional groups. In a particularly preferred embodiment, the inkjet ink of the present invention comprises a difunctional monomer.

The functional group of the radiation-curable monomer having two or more functional groups, which is utilised in the ink of the present invention may be the same or different but must take part in the polymerisation reaction on curing. Examples of such functional groups include any groups that are capable of polymerising upon exposure to radiation and are preferably selected from a (meth)acrylate group and a vinyl ether group.

The radiation-curable monomer having two or more functional groups may possess different degrees of functionality, and a mixture including combinations of di, tri and higher functionality monomers may be used.

The substituents of the radiation-curable monomer having two or more functional groups are not limited other than by the constraints imposed by the use in an ink-jet ink, such as viscosity, stability, toxicity etc. The substituents are typically alkyl, cycloalkyl, aryl and combinations thereof, any of which may be interrupted by heteroatoms. Non-limiting examples of substituents commonly used in the art include C₁₋₁₈ alkyl, C₃₋₁₈ cycloalkyl, C₆₋₁₀ aryl and combinations thereof, such as C₆₋₁₀ aryl- or C₃₋₁₈ cycloalkyl-substituted C₁₋₁₈ alkyl, any of which may be interrupted by 1-10 heteroatoms, such as oxygen or nitrogen, with nitrogen further substituted by any of the above described substituents. The substituents may together also form a cyclic structure. (The same groups may also be used for difunctional monomers.)

In a preferred embodiment, the ink of the present invention comprises 5 to 35% by weight of radiation-curable monomers having two or more functional groups, based on the total weight of the ink.

Examples of the radiation-curable monomer having two or more functional groups include difunctional (meth)acrylate monomers, multifunctional (meth)acrylate monomers, divinyl ether monomers and vinyl ether (meth)acrylate monomers. Mixtures of radiation-curable monomer having two or more functional groups may also be used.

Difunctional (meth)acrylate monomers are well known in the art and a detailed description is therefore not required. Preferred examples include decanediol diacrylate (DDDA), hexanediol diacrylate (HDDA), tricyclodecanedimethanol diacrylate (TCDDMDA), polyethyleneglycol diacrylate (for example tetraethyleneglycol diacrylate), dipropyleneglycol diacrylate, neopentylglycol diacrylate, 3-methyl pentanediol diacrylate, and the acrylate esters of ethoxylated or propoxylated glycols and polyols, for example, propoxylated neopentyl glycol diacrylate, and mixtures thereof.

In addition, suitable difunctional methacrylate monomers also include esters of methacrylic acid (i.e. methacrylates), such as decanediol dimethacrylate, hexanediol dimethacrylate, triethyleneglycol dimethacrylate, diethyleneglycol dimethacrylate, ethyleneglycol dimethacrylate, 1,4-butanediol dimethacrylate and mixtures thereof.

Preferably, the difunctional (meth)acrylate monomer is selected from decanediol diacrylate, hexanediol diacrylate, propoxylated neopentyl glycol diacrylate, dipropylene glycol diacrylate, and mixtures thereof. In a particularly preferred embodiment, the one or more difunctional (meth)acrylate monomers comprises 1,10-decanediol diacrylate (DDDA).

Preferably, the ink of the present invention comprises 5 to 25% by weight of a difunctional (meth)acrylate monomer, based on the total weight of the ink. However, for some applications of the present invention, the amount present may be higher and in such a preferred embodiment, the ink of the present invention comprises 10 to 80% by weight of a difunctional (meth)acrylate monomer, based on the total weight of the ink.

Multifunctional (which do not include difunctional) monomers are well known in the art and a detailed description is therefore not required. Multifunctional has its standard meaning, i.e. tri or higher, that is three or more groups, respectively, which take part in the polymerisation reaction on curing.

Suitable multifunctional (meth)acrylate monomers (which do not include difunctional (meth)acrylate monomers) include tri-, tetra-, penta-, hexa-, hepta- and octa-functional monomers. Examples of the multifunctional acrylate monomers that may be included in the inkjet inks include trimethylolpropane triacrylate, dipentaerythritol triacrylate, tri(propylene glycol) triacrylate, bis(pentaerythritol) hexaacrylate, and the acrylate esters of ethoxylated or propoxylated glycols and polyols, for example, ethoxylated trimethylolpropane triacrylate, and mixtures thereof. Suitable multifunctional (meth)acrylate monomers also include esters of methacrylic acid (i.e. methacrylates), such as trimethylolpropane trimethacrylate. Mixtures of (meth)acrylates may also be used.

Preferably, the ink of the present invention comprises 5 to 25% by weight of a multifunctional (meth)acrylate monomer, based on the total weight of the ink. However, for some applications of the present invention, the amount present may be higher and in such a preferred embodiment, the ink of the present invention comprises 10 to 80% by weight of a multifunctional (meth)acrylate monomer, based on the total weight of the ink.

The radiation-curable monomer having two or more functional groups, based on the total weight of the ink, may have at least one vinyl ether functional group. Examples are well known in the art and include vinyl ethers such as triethylene glycol divinyl ether, diethylene glycol divinyl ether, 1,4-cyclohexanedimethanol divinyl ether and 2-(2-vinyloxyethoxy)ethyl acrylate, bis[4-(vinyloxy)butyl] 1,6-hexanediylbiscarbamate, bis[4-(vinyloxy)butyl] isophthalate, bis[4-(vinyloxy)butyl] (methylenedi-4,1-phenylene), bis[4-(vinyloxy)butyl] succinate, bis[4-(vinyloxy)butyl]terephthalate, bis[4-(vinyloxymethyl)cyclohexylmethyl] glutarate, 1,4-butanediol divinyl ether, 1,4-butanediol vinyl ether, butyl vinyl ether, tert-butyl vinyl ether, 2-chloroethyl vinyl ether, 1,4-cyclohexanedimethanol divinyl ether, cyclohexyl vinyl ether, di(ethylene glycol) vinyl ether, diethyl vinyl orthoformate, dodecyl vinyl ether, ethylene glycol vinyl ether, 2-ethylhexyl vinyl ether, ethyl-1-propenyl ether, ethyl vinyl ether, isobutyl vinyl ether, phenyl vinyl ether, propyl vinyl ether, and tris[4-(vinyloxy)butyl] trimellitate.

(Meth)acrylate is intended herein to have its standard meaning, i.e. acrylate and/or methacrylate.

Monomers typically have a molecular weight of less than 600, preferably more than 200 and less than 450. Monomers are typically added to inkjet inks to reduce the viscosity of the inkjet ink. They therefore preferably have a viscosity of less than 150 mPas at 25° C., more preferably less than 100 mPas at 25° C. and most preferably less than 20 mPas at 25° C. Monomer viscosities can be measured using an ARG2 rheometer manufactured by T.A. Instruments, which uses a 40 mm oblique/2° steel cone at 25° C. with a shear rate of 25 s⁻¹.

The ink of the present invention may further comprise a radiation-curable (i.e. polymerisable) oligomer, such as a (meth)acrylate oligomer.

The term “curable oligomer” has its standard meaning in the art, namely that the component is partially reacted to form a pre-polymer having a plurality of repeating monomer units, which is capable of further polymerisation. The oligomer preferably has a molecular weight of at least 450 and preferably at least 600 (whereas monomers typically have a molecular weight below these values). The molecular weight is preferably 4,000 or less. Molecular weights (number average) can be calculated if the structure of the oligomer is known or molecular weights can be measured using gel permeation chromatography using polystyrene standards.

The degree of functionality of the oligomer determines the degree of crosslinking and hence the properties of the cured ink. The oligomer is preferably multifunctional meaning that it contains on average more than one reactive functional group per molecule. The average degree of functionality is preferably from 2 to 6.

Oligomers are typically added to inkjet inks to increase the viscosity of the inkjet ink or to provide film-forming properties such as hardness or cure speed. They therefore preferably have a viscosity of 150 mPas or above at 25° C. Preferred oligomers for inclusion in the ink of the invention have a viscosity of 0.5 to 10 Pas at 50° C. Oligomer viscosities can be measured using an ARG2 rheometer manufactured by T.A. Instruments, which uses a 40 mm oblique/2° steel cone at 60° C. with a shear rate of 25 s⁻¹.

Radiation-curable oligomers comprise a backbone, for example a polyester, urethane, epoxy or polyether backbone, and one or more radiation-curable groups. The oligomer preferably comprises a polyester backbone. The polymerisable group can be any group that is capable of polymerising upon exposure to radiation. Preferably the oligomers are (meth)acrylate oligomers.

Particularly preferred radiation-curable oligomers are polyester acrylate oligomers as these have excellent adhesion and elongation properties. Most preferred are di-, tri-, tetra-, penta- or hexa-functional polyester acrylates, as these yield films with good solvent resistance.

More preferably, the radiation-curable oligomer is an amine-modified polyester acrylate oligomer. Such a radiation-curable oligomer is commercially available as Ebecryl 80.

Other suitable examples of radiation-curable oligomers include epoxy based materials such as bisphenol A epoxy acrylates and epoxy novolac acrylates, which have fast cure speeds and provide cured films with good solvent resistance.

In one embodiment the radiation-curable oligomer polymerises by free-radical polymerisation. Preferably, the radiation-curable oligomer cures upon exposure to radiation in the presence of a photoinitiator to form a crosslinked, solid film.

The total amount of the oligomer is preferably from 1-15% by weight, based on the total weight of the ink. Preferably the oligomer is present from 2-5% by weight, based on the total weight of the ink.

The ink of the present invention may further comprise an α,β-unsaturated ether monomer, which can polymerise by free-radical polymerisation and may be useful for reducing the viscosity of the ink when used in combination with one or more (meth)acrylate monomers. Examples are well known in the art and include vinyl ethers such as triethylene glycol divinyl ether, diethylene glycol divinyl ether, 1,4-cyclohexanedimethanol divinyl ether and ethylene glycol monovinyl ether. Mixtures of α,β-unsaturated ether monomers may be used.

The ink of the present invention may also include radiation-curable material, which is capable of polymerising by cationic polymerisation. Suitable materials include, oxetanes, cycloaliphatic epoxides, bisphenol A epoxides, epoxy novolacs and the like. The radiation-curable material according to this embodiment may comprise a mixture of cationically curable monomer and oligomer. For example, the radiation-curable material may comprise a mixture of an epoxide oligomer and an oxetane monomer.

In the embodiment where the ink comprises radiation-curable material, which polymerises by cationic polymerisation, the ink must also comprise a cationic photoinitiator.

In the case of a cationically curable system, any suitable cationic initiator can be used, for example sulfonium or iodonium based systems. Non limiting examples include: Rhodorsil PI 2074 from Rhodia; MC AA, MC BB, MC CC, MC CC PF, MC SD from Siber Hegner; UV9380c from Alfa Chemicals; Uvacure 1590 from UCB Chemicals; and Esacure 1064 from Lamberti spa.

Preferably however, the ink of the present invention cures by free radical polymerisation only and hence the ink is substantially free of radiation-curable material, which polymerises by cationic polymerisation.

The inkjet ink of the present invention is radiation-curable and comprises one or more photoinitiators and in particular, a thioxanthone photoinitiator as discussed hereinabove. In a preferred embodiment, the inkjet ink of the present invention comprises one or more additional photoinitiators. In other words, the inkjet ink of the present invention comprises a thioxanthone photoinitiator and one or more further photoinitiators.

Preferably, the ink of the present invention preferably comprises one or more additional free radical photoinitiators. Free radical photoinitiators can be selected from any of those known in the art. For example, benzophenone, 1-hydroxycyclohexyl phenyl ketone, 1-[4-(2-hydroxyethoxy)-phenyl]-2-hydroxy-2-methyl-1-propane-1-one, 2-benzyl-2-dimethylamino-(4-morpholinophenyl)butan-1-one, benzil dimethylketal, 2,4,6-trimethylbenzoyl-diphenylphosphine oxide, bis(2,4,6-trimethylbenzoyl)-phenylphosphine oxide and bis(2,6-dimethylbenzoyl)-2,4,4-trimethylpentylphosphine oxide. Such photoinitiators are known and commercially available such as, for example, under the trade names Irgacure, Darocur and Lucirin (from BASF).

In a preferred embodiment, the inkjet ink of the present invention is an LED-curable inkjet ink. Colour shift is particularly problematic for LED-curable inkjets. In this respect, surface active photoinitiators, such as thioxanthone photoinitiators, such as ITX or DETX, must be included in LED-curable inkjet inks in order to achieve adequate surface cure. As discussed above, LED-curable inks including such photoinitiators suffer from colour shift. It has surprisingly been found however that the inclusion of MEHQ reduces colour shift in LED-curable inkjet inks.

In a preferred embodiment, the additional one or more photoinitiators present in the ink of the present invention is tailored for UV LED light. By tailored for UV LED light, it is meant that the photoinitiators absorb the radiation which is emitted by the UV LED light source. Preferably, the one or more additional photoinitiators present in the ink of the present invention absorbs radiation in a region of from 360 nm to 410 nm and absorbs sufficient radiation to cure the ink within a 50 nm or less, preferably 30 nm or less, most preferably 15 nm or less bandwidth.

In a preferred embodiment, the one or more additional photoinitiators comprises a phosphine oxide photoinitiator, such as TPO and BAPO. In a particularly preferred embodiment, the one or more additional photoinitiators comprises 2,4,6-trimethylbenzoyl-diphenylphosphine oxide (TPO).

In a preferred embodiment, the amount of one or more phosphine oxide photoinitiator present in the ink is 1 to 20% by weight, based on the total weight of the ink.

In a further preferred embodiment, the inkjet ink comprises two or more additional photoinitiators.

Preferably, the total amount of photoinitiator, including a thioxanthone photoinitiator, present in the ink of the present invention is 1-20% by weight, based on the total weight of the ink.

The inkjet ink of the present invention may further comprise a colouring agent, which may be either dissolved or dispersed in the liquid medium of the ink. Alternatively, the ink may be colourless and free of colouring agent. The colouring agent can be any of a wide range of suitable colouring agents that would be known to the person skilled in the art. Preferably the colouring agent is a dispersible pigment, of the types known in the art and commercially available such as, for example, under the trade-names Paliotol (available from BASF plc), Cinquasia, Irgalite (both available from Ciba Speciality Chemicals) and Hostaperm (available from Clariant UK).

The pigment may be of any desired colour such as, for example, Pigment Yellow 13, Pigment Yellow 83, Pigment Yellow 120, Pigment Red 9, Pigment Red 184, Pigment Blue 15:3, Pigment Green 7, Pigment Violet 19, Pigment Black 7. Especially useful are black and the colours required for trichromatic process printing. Mixtures of pigments may be used.

The inks may be in the form of a multi-chromatic inkjet ink set, which typically comprises a cyan ink, a magenta ink, a yellow ink and a black ink (a so-called trichromatic set). The inks in a trichromatic set can be used to produce a wide range of colours and tones.

The total proportion of pigment present is preferably from 0.5 to 15% by weight, more preferably from 1 to 10% by weight, based on the total weight of the ink. A higher concentration of pigment may be required for white inks, however, for example up to and including 30% by weight, or 15% by weight based on the total weight of the ink.

In a preferred embodiment, the ink of the present invention comprises a cyan colouring agent, and preferably a cyan pigment. The cyan pigment is dispersed in the liquid medium of the ink and is typically in the form of a powdered cyan pigment. A preferred blue pigment is Heliogen Blue 7110 F available from BASF. In a preferred embodiment, the ink comprises 1-10% by weight of the cyan pigment, based on the total weight of the ink. As previously discussed, yellow shift is particularly problematic for cyan inks, as cyan is at the opposite end of the colour spectrum to yellow. Yellow shift is however a problem for all colours of inks, including black inks and other colours of the trichromatic process printing, including magenta and yellow. In yellow inks, yellow shift changes the yellow hue of the ink.

The inkjet ink of the present invention dries primarily by curing, i.e. by the polymerisation of the monomers present, as discussed hereinabove, and hence is a curable ink. The ink does not, therefore, require the presence of water or a volatile organic solvent to effect drying of the ink. The absence of water and volatile organic solvents means that the ink does not need to be dried to remove the water/solvent. However, water and volatile organic solvents have a significant viscosity-lowering effect making formulation of the ink in the absence of such components significantly more challenging.

Accordingly, the inkjet ink of the present invention is preferably substantially free of water and volatile organic solvents. Preferably, the inkjet ink comprises less than 5% by weight of water and volatile organic solvent combined, preferably less than 3% by weight combined, more preferably, less than 2% by weight combined and most preferably less than 1% by weight combined, based on the total weight of the ink. Some water will typically be absorbed by the ink from the air and solvents may be present as impurities in the components of the inks, but such low levels are tolerated.

The inks of the present invention may comprise a passive (or “inert”) thermoplastic resin. Passive resins are resins which do not enter into the curing process, i.e. the resin is free of functional groups which polymerise under the curing conditions to which the ink is exposed. In other words, resin is not a radiation-curable material. The resin may be selected from epoxy, polyester, vinyl, ketone, nitrocellulose, phenoxy or acrylate resins, or a mixture thereof and is preferably a poly(methyl (meth)acrylate) resin. The resin has a weight-average molecular weight of 70-200 KDa and preferably 100-150 KDa, as determined by GPC with polystyrene standards. Particularly preferred resins are Paraloid® All from Rohm and Haas and BR-113 from Dianal Resins. The resin is preferably present at 1-5% by weight, based on the total weight of the ink.

Other components of types known in the art may be present in the ink of the present invention to improve the properties or performance. These components may be, for example, additional surfactants, defoamers, dispersants, stabilisers against deterioration by heat or light, reodorants, flow or slip aids, biocides and identifying tracers. In a preferred embodiment, photosensitisers are added to the ink, which are selected to absorb strongly in the desired wavelength band of UV LED radiation source and are able to transfer energy to the photoinitiators of the ink.

In a preferred embodiment, the inkjet ink of the present invention further comprises a dispersant. The dispersant is not particularly limited and the formulator is free to include any dispersant in the ink of the present invention to improve the properties or performance of the ink. This dispersant can include any dispersant readily available and known in the art in inkjet inks. A particularly preferred dispersant is Solsperse® 32000 from Lubrizol Limited.

In a preferred embodiment, the inkjet ink of the present invention further comprises an additional stabiliser. The stabiliser is additional in the sense that MEHQ of the present invention is a stabiliser. The additional stabiliser is not particularly limited and the formulator is free to include any additional stabiliser in the ink of the present invention to improve the properties or performance of the ink. This additional stabiliser can include any additional stabiliser readily available and known in the art in inkjet inks. A particularly preferred additional stabiliser is Florstab UV-12 from Kromachem Limited.

In a preferred embodiment, the inkjet ink of the present invention further comprises a surfactant. The surfactant is not particularly limited and the formulator is free to include any surfactant in the ink of the present invention to improve the properties or performance of the ink. This surfactant can include any surfactant readily available and known in the art in inkjet inks. A particularly preferred surfactant is BYK-307 from BYK-Chemie GmbH.

The amounts by weight provided herein are based on the total weight of the ink.

The inkjet ink of the present invention exhibits a desirable low viscosity (200 mPas or less, preferably 100 mPas or less and more preferably 30 mPas or less at 25° C.). In a preferred embodiment, the viscosity of the inkjet ink is 10 mPas to 30 mPas at 25° C.

In order to produce a high quality printed image a small jetted drop size is desirable. Furthermore, small droplets have a higher surface area to volume ratio when compared to larger drop sizes, which facilitates evaporation of solvent from the jetted ink. Small drop sizes therefore offer advantages in drying speed. Preferably the inkjet ink is jetted at drop sizes below 90 picolitres, preferably below 35 picolitres and most preferably below 10 picolitres.

To achieve compatibility with print heads that are capable of jetting drop sizes of 90 picolitres or less, a low viscosity ink is required. A viscosity of 30 mPas or less at 25° C. is preferred, for example, 10 to 12 mPas, 18 to 20 mPas, or 24 to 26 mPas.

Ink viscosity may be measured using a Brookfield viscometer fitted with a thermostatically controlled cup and spindle arrangement, such as a DV1 low-viscosity viscometer running at 20 rpm at 25° C. with spindle 00.

Print heads account for a significant portion of the cost of an entry level printer and it is therefore desirable to keep the number of print heads (and therefore the number of inks in the ink set) low. Reducing the number of print heads can reduce print quality and productivity. It is therefore desirable to balance the number of print heads in order to minimise cost without compromising print quality and productivity.

The inkjet ink may be prepared by known methods such as stirring with a high-speed water-cooled stirrer, or milling on a horizontal bead-mill.

The present invention also provides a method of inkjet printing the inkjet ink of the present invention. Specifically, the present invention provides a method of inkjet printing comprising inkjet printing the inkjet ink of the present invention onto a substrate and curing the ink by exposing the printed ink to a UV radiation source, which is preferably a UV LED radiation source. The inventors have surprisingly found that the ink of the present invention is particularly suitable as an ink which can be cured using a UV LED light source, whilst minimising colour shift and maintaining surface cure and film-forming properties.

In the method of inkjet printing of the present invention, the inkjet ink is printed onto a substrate. Printing is performed by inkjet printing, e.g. on a single-pass inkjet printer, for example for printing (directly) onto a substrate, on a roll-to-roll printer or a flat-bed printer. As discussed above, inkjet printing is well known in the art and a detailed description is not required.

The ink is jetted from one or more reservoirs or printing heads through narrow nozzles on to a substrate to form a printed image. The substrate is not limited. Examples of substrates include those composed of PVC, polyester, polyethylene terephthalate (PET), PETG, polyethylene, polypropylene, and all cellulosic materials or their mixtures/blends with the aforementioned synthetic materials.

In the method of the present invention, after inkjet printing the inkjet ink onto the substrate, the printed image is then exposed to a UV radiation source, preferably UV LED light, to cure the inkjet ink.

Any suitable radiation source may be used. Suitable UV sources include mercury discharge lamps, fluorescent tubes, light emitting diodes (LEDs), flash lamps and combinations thereof. In a preferred embodiment, a UV LED light source is used to cure the ink.

UV LED light is emitted from a UV LED light source. UV LED light sources comprise one or more LEDs and are well known in the art. Thus, a detailed description is not required.

It will be understood that UV LED light sources emit radiation having a spread of wavelengths. The emission of UV LED light sources is identified by the wavelength which corresponds to the peak in the wavelength distribution. Compared to conventional mercury lamp UV sources, UV LED light sources emit UV radiation over a narrow range of wavelengths on the wavelength distribution. The width of the range of wavelengths on the wavelength distribution is called a wavelength band. LEDs therefore have a narrow wavelength output when compared to other sources of UV radiation. By a narrow wavelength band, it is meant that at least 90%, preferably at least 95%, of the radiation emitted from the UV LED light source has a wavelength within a wavelength band having a width of 50 nm or less, preferably, 30 nm or less, most preferably 15 nm or less.

In a preferred embodiment, at least 90%, preferably at least 95%, of the radiation emitted from the UV LED light source has a wavelength in a band having a width of 50 nm or less, preferably 30 nm or less, most preferably 15 nm or less.

Preferably, the wavelength of the UV LED source substantially matches the absorption profile of the ink. In a preferred embodiment, the wavelength distribution of the UV LED light peaks at a wavelength of from 360 nm to 410 nm. In a particularly preferred embodiment, the wavelength distribution of the UV LED light peaks at a wavelength of around 365 nm, 395 nm, 400 nm or 405 nm. The ink of the present invention is preferably formulated to respond to the emission of the UV LED source.

In a particularly preferred embodiment, the wavelength distribution of the UV LED light peaks at a wavelength of from 360 nm to 410 nm, and at least 90%, preferably at least 95%, of the radiation has a wavelength in a band having a width of 50 nm or less, preferably 30 nm or less, most preferably 15 nm or less. In a particularly preferred embodiment, the wavelength distribution of the UV LED light peaks at a wavelength of around 365 nm, 395 nm, 400 nm or 405 nm, and at least 90%, preferably at least 95%, of the radiation has a wavelength in a band having a width of 50 nm or less, preferably 30 nm or less, most preferably 15 nm or less.

LEDs have a longer lifetime and exhibit no change in the power/wavelength output over time. LEDs also have the advantage of switching on instantaneously with no thermal stabilisation time and their use results in minimal heating of the substrate.

Upon exposure to a radiation source, the ink cures to form a relatively thin polymerised film. The ink of the present invention typically produces a printed film having a thickness of 1 to 20 μm, preferably 1 to 10 μm, for example 2 to 5 μm. Film thicknesses can be measured using a confocal laser scanning microscope.

The exposure to UV LED light may be performed in an inert atmosphere, e.g. using a gas such as nitrogen, in order to assist curing of the ink, although this is not required to achieve full cure, including surface cure owing to the components present in the ink of the present invention.

The present invention further provides the use of MEHQ for reducing colour shift in an inkjet ink, preferably a LED-curable inkjet ink.

By reducing colour shift, it is meant that the change in the degree of colour shift of the ink post-cure is reduced and hence the ink is more colour stable. Colour profiling of the cured ink image can then be carried out more efficiently.

The present invention also provides a cartridge containing the inkjet ink as defined herein. It also provides a printed substrate having the ink as defined herein printed thereon.

The invention will now be described with reference to the following examples, which are not intended to be limiting.

### EXAMPLES

### Reference Example 1

In order to show colour shift in commercially available inks, the following inkjet inks were prepared according to the formulations set out in Table 1 and Table 2. The inkjet ink formulations were prepared by mixing the components in the given amounts. Amounts are given as weight percentages based on the total weight of the ink.

TABLE 1
LED-curable inks

| | | | Ink 3 | Ink 4 |
|---|---|---|---|---|
| | Ink 1 | Ink 2 | Low yellowing | Low yellowing |
| Component | Cyan | Magenta | cyan | magenta |
| PEA | 33.12 | 23.60 | 31.72 | 22.20 |
| IBOA | 11.90 | 11.60 | 11.90 | 11.60 |
| DDDA | 20.00 | 20.00 | 20.00 | 20.00 |
| NVC | 16.50 | 19.80 | 16.50 | 19.80 |
| UV12 | 0.40 | 0.40 | 0.40 | 0.40 |
| BR113 | 1.48 | 1.00 | 1.48 | 1.00 |
| Cyan dispersion | 6.00 | | 6.00 | |
| Magenta | | 13.00 | | 13.00 |
| dispersion | | | | |
| Irgacure 819 | 2.80 | 2.80 | | |
| ITX (2-Isomer) | 4.00 | 4.00 | 1.00 | 1.00 |
| TPO | 2.80 | 2.80 | 10.00 | 10.00 |
| Byk307 | 1.00 | 1.00 | 1.00 | 1.00 |

TABLE 2
Mercury-curable inks

| | | | | | Ink 9 | Ink 10 |
|---|---|---|---|---|---|---|
| | | | | | Low | Low |
| | | | Ink 7 | Ink 8 | yellowing | yellowing |
| | Ink 5 | Ink 6 | Light | Light | light | light |
| Component | Cyan | Magenta | cyan | magenta | cyan | magenta |
| PEA | 24.68 | 16.75 | 28.34 | 22.87 | 30.39 | 26.17 |
| IBOA | 11.90 | 11.48 | 11.90 | 11.60 | 11.90 | 11.60 |
| DDDA | 20.00 | 20.00 | 20.00 | 20.00 | 20.00 | 20.00 |
| NVC | 16.50 | 20.00 | 16.50 | 19.80 | 16.50 | 19.80 |
| UV12 | 0.50 | 0.50 | 0.50 | 0.50 | 0.50 | 0.50 |
| Craynor | 5.00 | 2.00 | 5.50 | 5.00 | 5.10 | 4.20 |
| CN964 A85 | | | | | | |
| Cyan | 6.00 | | 1.13 | | 1.13 | |
| dispersion | | | | | | |
| Magenta | | 13.00 | | 3.25 | | 3.25 |
| dispersion | | | | | | |
| Solsperse | | | 0.71 | 0.71 | 0.71 | 0.71 |
| 32000 | | | | | | |
| ITX (2- | 0.80 | 0.80 | 0.80 | 0.80 | | |
| Isomer) | | | | | | |
| TPO | 8.01 | 8.01 | 8.01 | 8.01 | 8.01 | 8.01 |
| EDB | 0.85 | 1.70 | 0.85 | 1.70 | | |
| Benzo- | 2.88 | 2.88 | 2.88 | 2.88 | 2.88 | 2.88 |
| phenone | | | | | | |
| Irgacure 184 | 1.88 | 1.88 | 1.88 | 1.88 | 1.88 | 1.88 |
| Byk307 | 1.00 | 1.00 | 1.00 | 1.00 | 1.00 | 1.00 |

UV12 is a stabiliser. BR113 is a passive resin. CN964 A85 is a urethane acrylate. Solsperse 32000 is a dispersant. Irgacure 819, ITX, TPO, benzophenone and Irgacure 184 are photoinitiators. EDB is an amine synergist. Byk307 is a surfactant.

The cyan and magenta pigment dispersions of the inks of Tables 1 and 2 were prepared according to the following formulations. The cyan pigment dispersion comprises 59% PEA, 1% stabiliser, 10% dispersant and 30% blue pigment. The magenta pigment dispersion comprises 56.5% PEA, 1.5% stabiliser, 12% dispersant and 30% magenta pigment. The dispersions were prepared by mixing the components in the given amounts and passing the mixture through a bead mill until the dispersion had a particle size of less than 0.3 microns. Amounts are given as weight percentages based on the total weight of the dispersion.

The inks of Tables 1 and 2 were drawn down onto white self-adhesive PVC using a K bar automatic wire wound coater to achieve a controlled wet film of 12 microns. The LED-curable inks (Table 1) were cured using a Phoseon 20 W LED lamp (395 nm, 800-1000 mJ/cm²) set at 20% power at 90 m/min speed. The mercury-curable inks (Table 2) were cured using an Integration Technology 1 W medium pressure mercury arc lamp at 100% power, 25 m/min.

The cured ink films were assessed for surface cure by applying a piece of photo paper on top of the film, applying thumb pressure for a period of 30 seconds, removing the paper and checking that no ink offset had transferred from the film to the paper. All inks had adequate surface cure post-cure.

Colour shift post-cure was measured on a photospectrometer for L*, a* and b* values over a period of 24 hours and the delta E values found. The principal change in the L*, a* and b* values was on the b* axis in the yellow quadrant and therefore, the delta E values are an indicative measure of Δb*. The results of the colour shift of the inks are set out in FIGS. 1-3 where delta E values for the inks over 24 hours after cure are shown.

As can be seen from FIGS. 1-3, colour shift is reduced when the amount of ITX is reduced. Put another way, colour shift increases as the level of ITX increases.

This can be seen by comparing ink 7 with ink 9, and ink 8 with ink 10, see FIG. 1. Ink 7 and ink 9 have equivalent formulations, with the exception that ITX has been removed from ink 9 and other components of this ink have been adjusted accordingly. Likewise, ink 8 and ink 10 have equivalent formulations with the exception that ITX has been removed in ink 10 and other components of this ink have been adjusted accordingly. The delta E value over a period of 24 hours for ink 7 is much higher than that of ink 9. Further, the delta E value over a period of 24 hours for ink 8 is much higher than that of ink 10.

This effect can also be seen by comparing ink 5 and ink 6 with ink 1 and ink 2, see FIG. 1. As previously discussed, in order to achieve adequate surface cure in LED-curable inks, it has previously been necessary to use thioxanthone photoinitiators, such as ITX and DETX, and often in higher amounts than required for conventionally cured inks. However, this results in increased colour shift, both immediately after curing and over a 24 hour period. This can be seen in the results for ink 1 and ink 2 in FIG. 1, which have a high colour shift immediately after cure and over 24 hours, as these inks contain a higher amount of ITX (required for good surface cure) compared to ink 5 and ink 6. This is in contrast to ink 5 and ink 6, which have comparable cure to ink 1 and ink 2 but have reduced ITX content. Ink 5 and ink 6 have a much lower colour shift when compared to ink 1 and ink 2 both immediately after curing and over 24 hours, see FIG. 1. It is clear that reducing the amount of ITX in the ink reduces the colour shift over 24 hours.

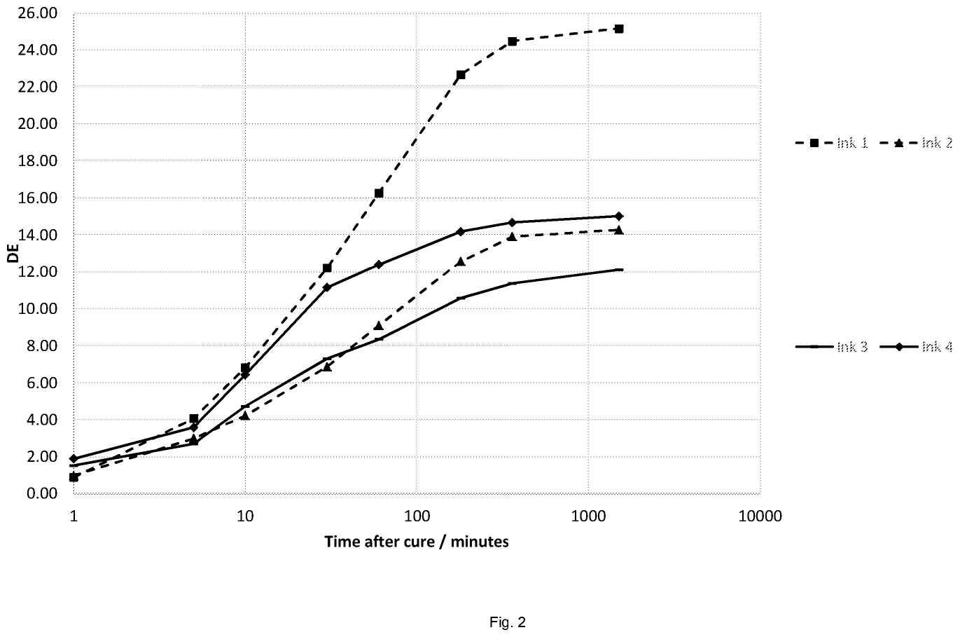

As can be seen in FIG. 2, a reduction in colour shift is achieved when reducing ITX, see ink 1 when compared to ink 3, and also ink 2 when compared with ink 4. However, even when the ITX is reduced to a level that provides acceptable cure when curing with LED (i.e. ink 3 and ink 4), it is still a much higher colour shift than inkjet inks which are formulated to be cured by other curing sources, such as mercury cure, as the level of ITX is much reduced in such inks as it is not required to achieve adequate surface cure. In this regard, comparing the lowest colour shift LED-curable inks in FIG. 2 (ink 3 and ink 4) with the lowest colour shift reduced ITX inks in FIG. 1 (ink 9 and ink 10), it can be seen that the level of colour shift is much higher for the LED inks as they require a higher level of ITX to achieve acceptable cure.

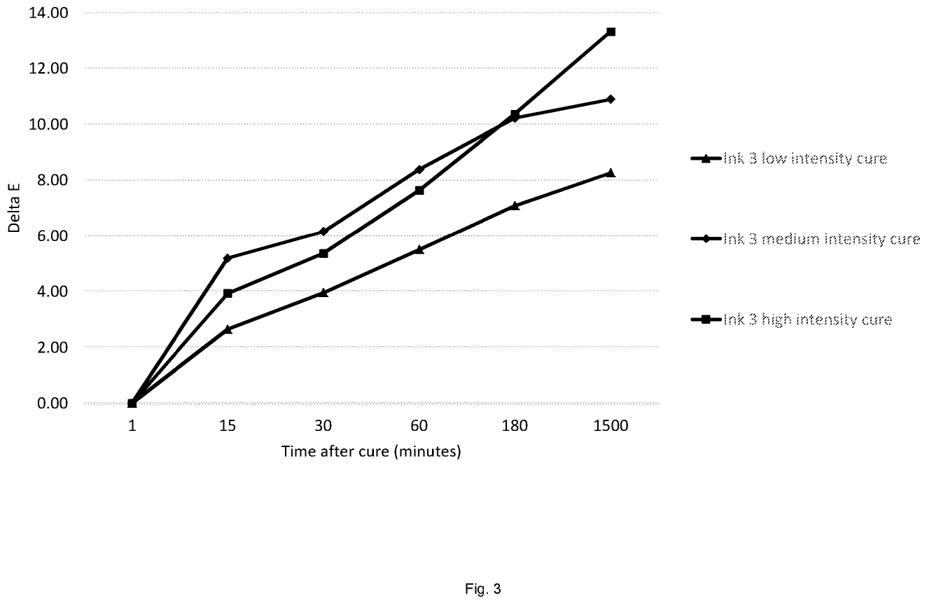

This problem can become particularly acute for high productivity platforms, such as the Inca onset, which currently require the use of high-intensity mercury lamps (X3=3400 mJ/cm²) to provide sufficient dose to cure the ink when printing in high productivity modes (short exposure under the UV lamp). In this regard, increasing the intensity of the curing source increases colour shift. In order to show this, ink 3 was cured by a low intensity, standard intensity and high intensity mercury lamp. The settings of the lamp are shown in Table 3. FIG. 3 shows how increased intensity can affect colour shift.

TABLE 3

| | | Intensity | Dose | Total dose |
|---|---|---|---|---|
| | Settings | mW/cm² | per pass | mJ/cm² |
| High | 100%, 50 m/min, 2 pass | 19962 | 439 | 878 |
| Low | 20%, 20 m/min, 4 pass | 3992 | 218.85 | 875.4 |
| Medium | 40%, 20 m/min, 2 pass | 7985 | 437.75 | 875.4 |

It is clear that increasing the intensity of the mercury lamp increases the colour shift of inks. Therefore, the delta E values recorded for the rest of the examples represent delta E values when the inks are cured to give tack-free films.

### Example 2

The following inkjet ink was prepared according to the formulation set out in Table 4. The inkjet ink formulation was prepared by mixing the components in the given amounts. Amounts are given as weight percentages based on the total weight of the ink.

TABLE 4

| Component | Ink 11 |
|---|---|
| PEA | 31.56 |
| IBOA | 11.9 |
| DDDA | 20.0 |
| NVC | 16.5 |
| MEHQ | 0.5 |
| UV22 | 0.2 |
| BR113 | 1.34 |
| Cyan dispersion | 6.0 |
| ITX | 1.0 |
| TPO | 10.0 |
| Byk 307 | 1.0 |

As can be seen, ink 3 and ink 11 differ in the stabiliser package present. Ink 3 comprises UV12. Ink 11 is the same as ink 3 but UV12 has been replaced with 0.5% MEHQ and 0.2% UV22.

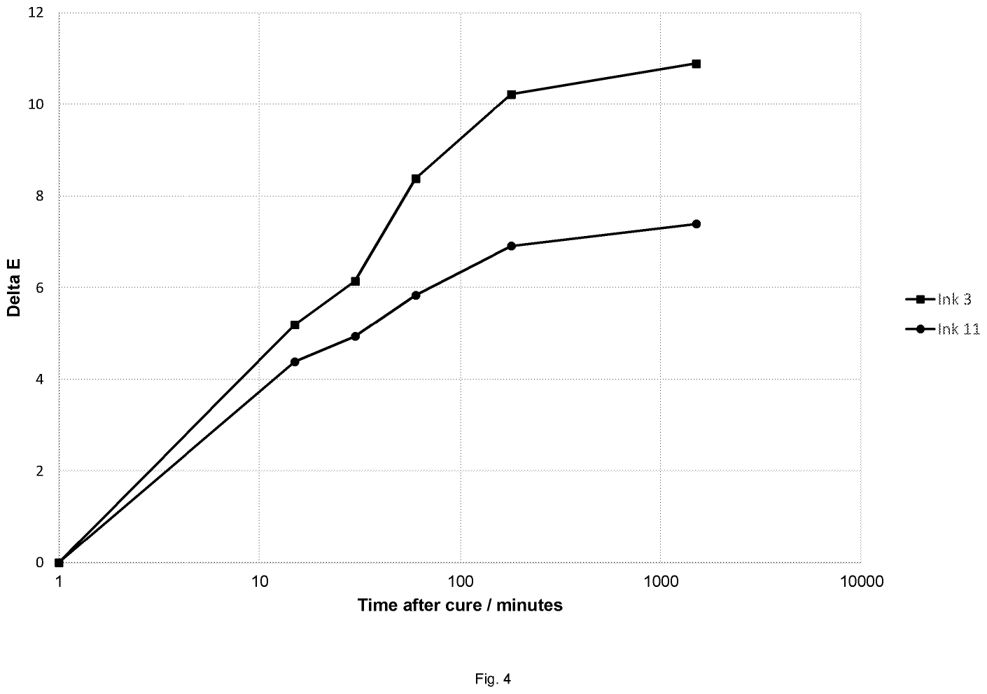

Ink 3 and ink 11 were drawn down onto white self-adhesive PVC using a K bar automatic wire wound coater to achieve a controlled wet film of 12 microns. They were then cured using a Phoseon 20 W LED lamp (395 nm, 800-1000 mJ/cm²) set at 40% power at 20 m/min speed, with two curing exposures at this setting. All inks had adequate surface cure post-cure as described above. Colour shift was then measured on a photospectrometer for L*, a* and b* values over a period of 24 hours and the delta E values found. Again, the principal change in the L*, a* and b* values is on the b* axis in the yellow quadrant and therefore, the delta E values are an indicative measure of Δb*. The results of the colour shift of ink 3 and ink 11 are set out in Tables 5 and 6, and FIG. 4 where delta E values for the inks over 24 hours after cure are shown.

TABLE 5

| | | Ink 3 (comparative) | | | |
|---|---|---|---|---|---|
| Interval | Time/minutes | L* | a* | b* | Delta E |
| Initial | 0 | 50.82 | −43.47 | −45.81 | 0.00 |
| 15 mins | 15 | 51.59 | −41.00 | −50.31 | 5.19 |
| 30 mins | 30 | 51.96 | −40.65 | −51.15 | 6.15 |
| 1 hour | 60 | 52.27 | −39.30 | −52.93 | 8.38 |
| 3 hours | 180 | 52.59 | −38.39 | −54.50 | 10.22 |
| 24 hours | 1500 | 53.17 | −38.55 | −55.24 | 10.89 |

The Δb* absolute value over 24 hours for ink 3 was 9.43.

TABLE 6

| | | Ink 11 | | | |
|---|---|---|---|---|---|
| Interval | Time/minutes | L* | a* | b* | Delta E |
| Initial | 0 | 51.74 | −41.15 | −49.74 | 0.00 |
| 15 mins | 15 | 52.48 | −39.38 | −52.99 | 3.77 |
| 30 mins | 30 | 52.66 | −39.00 | −53.66 | 4.56 |
| 1 hour | 60 | 52.66 | −38.80 | −53.99 | 4.94 |
| 3 hours | 180 | 52.93 | −38.15 | −54.93 | 6.11 |
| 24 hours | 1500 | 53.01 | −37.78 | −55.68 | 6.95 |

The Δb* absolute value over 24 hours for ink 11 was 5.94.

FIG. 4 shows that colour shift is significantly and surprisingly reduced after curing and over 24 hours by almost 50% through the introduction of MEHQ into an inkjet ink containing ITX, PEA and NVC. Ink stability (4 weeks at 40° C. and 6 weeks at 50° C.) shows the ink of the invention to be robust to storage at elevated temperatures, with less than 20% viscosity increase and no significant change in particle time or filtration performance.

### Example 3

The following inkjet inks were prepared according to the formulations set out in Table 7. The inkjet ink formulations were prepared by mixing the components in the given amounts. Amounts are given as weight percentages based on the total weight of the ink.

TABLE 7
LED-curable inks

| | Ink 12 | | | | |
|---|---|---|---|---|---|
| | (comparative) | | Ink 14 | Ink 15 | Ink 16 |
| | Low yellowing | Ink 13 | (comparative) | 0.5% MEHQ | (comparative) |
| Component | cyan | 0.5% MEHQ | 0.2% UV22 | and 0.2% UV22 | 0.5% UV22 |
| PEA | 31.86 | 31.76 | 32.06 | 31.56 | 31.76 |
| IBOA | 11.90 | 11.90 | 11.90 | 11.90 | 11.90 |
| DDDA | 20.00 | 20.00 | 20.00 | 20.00 | 20.00 |
| NVC | 16.50 | 16.50 | 16.50 | 16.50 | 16.50 |
| UV12 | 0.40 | | | | |
| UV22 | | | 0.20 | 0.20 | 0.50 |
| MEHQ | | 0.50 | | 0.50 | |
| BR113 | 1.34 | 1.34 | 1.34 | 1.34 | 1.34 |
| Cyan | 6.00 | 6.00 | 6.00 | 6.00 | 6.00 |
| dispersion | | | | | |
| ITX (2-Isomer) | 1.00 | 1.00 | 1.00 | 1.00 | 1.00 |
| TPO | 10.00 | 10.00 | 10.00 | 10.00 | 10.00 |
| Byk307 | 1.00 | 1.00 | 1.00 | 1.00 | 1.00 |

The cyan pigment dispersion is the same as that used in Example 1.

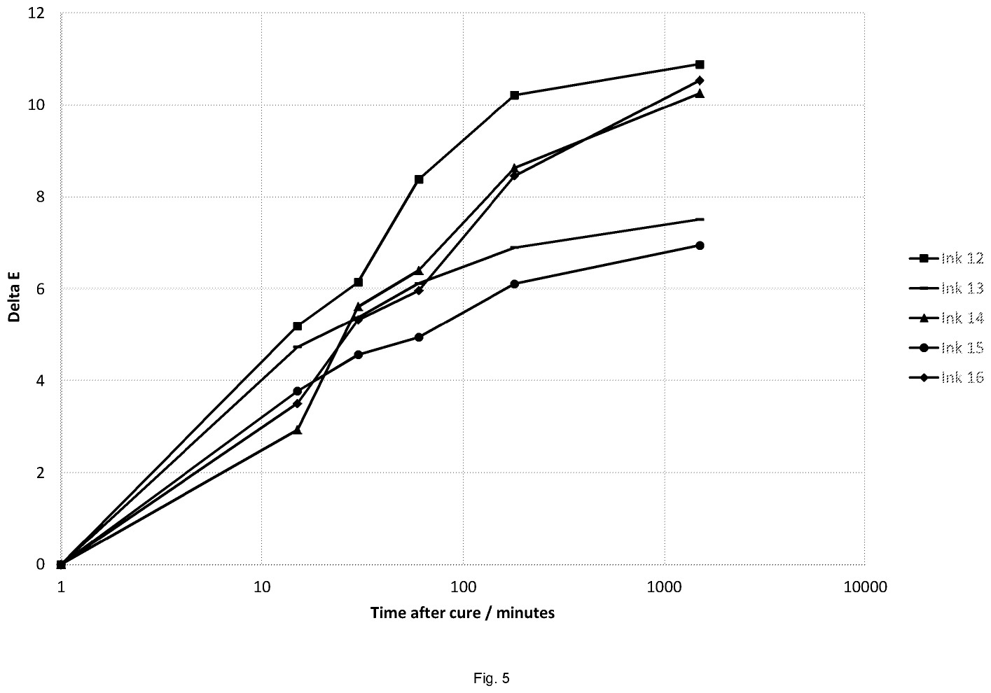

Inks 12-16 were drawn down onto white self-adhesive PVC using a K bar automatic wire wound coater to achieve a controlled wet film of 12 microns. The inks were then cured using a Phoseon 20 W LED lamp (395 nm, 800-1000 mJ/cm²) set at 40% power at 20 m/min speed and 2 passes. All inks had adequate surface cure post-cure as described above. Colour shift was then measured on a photospectrometer for L*, a* and b* values over a period of 24 hours and the delta E values found. Again, the principal change in the L*, a* and b* values is on the b* axis in the yellow quadrant and therefore, the delta E values are an indicative measure of Δb*. The results of the colour shift of the inks are set out in Tables 8-12 and FIG. 5 where delta E values for the inks over 24 hours after cure are shown.

TABLE 8

| | | Ink 12 (comparative) | | | |
|---|---|---|---|---|---|
| Interval | Time/minutes | L* | a* | b* | Delta E |
| Initial | 1 | 50.82 | −43.47 | −45.81 | 0.00 |
| 15 mins | 15 | 51.59 | −41.00 | −50.31 | 5.19 |
| 30 mins | 30 | 51.96 | −40.65 | −51.15 | 6.15 |
| 1 hour | 60 | 52.27 | −39.30 | −52.93 | 8.38 |
| 3 hours | 180 | 52.59 | −38.39 | −54.50 | 10.22 |
| 24 hours | 1500 | 53.17 | −38.55 | −55.24 | 10.89 |

The Δb* absolute value over 24 hours for ink 12 was 9.43.

TABLE 9

| | | Ink 13 | | | |
|---|---|---|---|---|---|
| Interval | Time/minutes | L* | a* | b* | Delta E |
| Initial | 1 | 51.36 | −41.21 | −49.43 | 0.00 |
| 15 mins | 15 | 52.38 | −39.10 | −53.54 | 4.73 |
| 30 mins | 30 | 52.48 | −38.76 | −54.08 | 5.37 |
| 1 hour | 60 | 52.47 | −38.34 | −54.72 | 6.12 |
| 3 hours | 180 | 52.69 | −37.89 | −55.33 | 6.90 |
| 24 hours | 1500 | 52.78 | −37.64 | −55.88 | 7.51 |

The Δb* absolute value over 24 hours for ink 13 was 6.45.

TABLE 10

| | | Ink 14 (comparative) | | | |
|---|---|---|---|---|---|
| Interval | Time/minutes | L* | a* | b* | Delta E |
| Initial | 1 | 50.68 | −42.59 | −47.23 | 0.00 |
| 15 mins | 15 | 51.52 | −41.31 | −49.73 | 2.93 |
| 30 mins | 30 | 51.85 | −40.02 | −52.08 | 5.61 |
| 1 hour | 60 | 51.99 | −39.61 | −52.74 | 6.40 |
| 3 hours | 180 | 52.34 | −38.41 | −54.59 | 8.63 |
| 24 hours | 1500 | 52.48 | −37.57 | −55.99 | 10.26 |

The Δb* absolute value over 24 hours for ink 14 was 8.76.

TABLE 11

| | | Ink 15 | | | |
|---|---|---|---|---|---|
| Interval | Time/minutes | L* | a* | b* | Delta E |
| Initial | 1 | 51.74 | −41.15 | −49.74 | 0.00 |
| 15 mins | 15 | 52.48 | −39.38 | −52.99 | 3.77 |
| 30 mins | 30 | 52.66 | −39.00 | −53.66 | 4.56 |
| 1 hour | 60 | 52.66 | −38.80 | −53.99 | 4.94 |
| 3 hours | 180 | 52.93 | −38.15 | −54.93 | 6.11 |
| 24 hours | 1500 | 53.01 | −37.78 | −55.68 | 6.95 |

The Δb* absolute value over 24 hours for ink 15 was 5.94.

TABLE 12

| | | Ink 16 (comparative) | | | |
|---|---|---|---|---|---|
| Interval | Time/minutes | L* | a* | b* | Delta E |
| Initial | 1 | 51.12 | −42.97 | −46.71 | 0.00 |
| 15 mins | 15 | 52.09 | −41.52 | −49.75 | 3.50 |
| 30 mins | 30 | 51.96 | −40.52 | −51.36 | 5.32 |
| 1 hour | 60 | 52.36 | −40.14 | −51.81 | 5.96 |
| 3 hours | 180 | 52.83 | −38.97 | −53.96 | 8.45 |
| 24 hours | 1500 | 52.92 | −37.72 | −55.67 | 10.54 |

The Δb* absolute value over 24 hours for ink 16 was 8.96.

FIG. 5 demonstrates that MEHQ is critical to the reduction in colour shift in inkjet inks and that this is not dependent on the presence of other stabilisers being present. In this regard, FIG. 5 shows the colour shift of ink 12. It also shows the colour shift when UV12 of ink 12 is replaced with UV22 (ink 14 and ink 16), MEHQ (ink 13) and a combination of MEHQ and UV22 (ink 15).

It is clear that the colour shift of ink 12, which comprises 0.4% UV12 is similar to that of ink 14 and ink 16, with UV12 replaced with 0.2% and 0.5% UV22, respectively. In contrast, the colour shift of ink 12, which comprises 0.4% UV12 is much higher than that of ink 13 and ink 15, with UV12 replaced with 0.5% MEHQ and 0.5% MEHQ/0.2% UV22, respectively. Further, ink 14 with UV12 replaced with 0.2% UV22 has a higher colour shift than that of ink 15 with UV12 replaced with a combination of 0.2% UV22 and 0.5% MEHQ.

Further, Tables 8-12 show the colouristic data for the inks represented in FIG. 5 and it can be seen that the initial yellowing (b*) of inks straight after cure is reduced for the inks containing MEHQ compared to the other inks without MEHQ, and that the final yellow level reaches the same point for all colours, so this is a genuine reduction in initial yellowing rather than delta E being affected by a genuine permanent hue shift.

The cure response of inks 12-16 was also measured to confirm that the degree of colour shift reduction was not caused by a reduction in overall cure response by the presence of the photostabilisers (causing less yellow chromophores to be developed) rather than the specific effect of MEHQ. The results are set out in Table 13.

In order to measure the cure response, inks 12-16 were again drawn down onto white self-adhesive PVC using a K bar automatic wire wound coater to achieve a controlled wet film of 12 microns. They were then cured using a Phoseon 20 W LED lamp (395 nm) set at 20% power at 40 m/min speed. The number of passes required for no surface offset for each ink are as detailed in Table 10, with 111 mL/cm² per pass. Offset was measured with AMRL photopaper test.

TABLE 13

| | Passes required for |
|---|---|
| Ink | no surface offset |
| 13 | 8 |
| 13 | 8 |
| 15 | 12 |

This confirms that the degree of colour shift reduction is not caused by reduction in overall cure response.

### Example 4

The following inkjet inks were prepared according to the formulations set out in Table 14. The inkjet ink formulations were prepared by mixing the components in the given amounts. Amounts are given as weight percentages based on the total weight of the ink.

TABLE 14

| | | Ink 18 | Ink 19 |
|---|---|---|---|
| | Ink 17 (comparative) | 1% ITX and | 1% DETX and |
| Component | 1% DETX | 0.5% MEHQ | 0.5% MEHQ |
| PEA | 31.86 | 31.76 | 31.76 |
| IBOA | 11.90 | 11.90 | 11.90 |
| NVC | 16.50 | 16.50 | 16.50 |
| DDDA | 20.00 | 20.00 | 20.00 |
| UV12 | 0.40 | | |
| BR113 | 1.34 | 1.34 | 1.34 |
| MEHQ | | 0.50 | 0.50 |
| Cyan dispersion | 6.00 | 6.00 | 6.00 |
| Speedcure ITX | | 1.00 | |
| DETX | 1.00 | | 1.00 |
| TPO | 10.00 | 10.00 | 10.00 |
| BYK 307 | 1.00 | 1.00 | 1.00 |

The cyan pigment dispersion was the same as that used in Example 1.

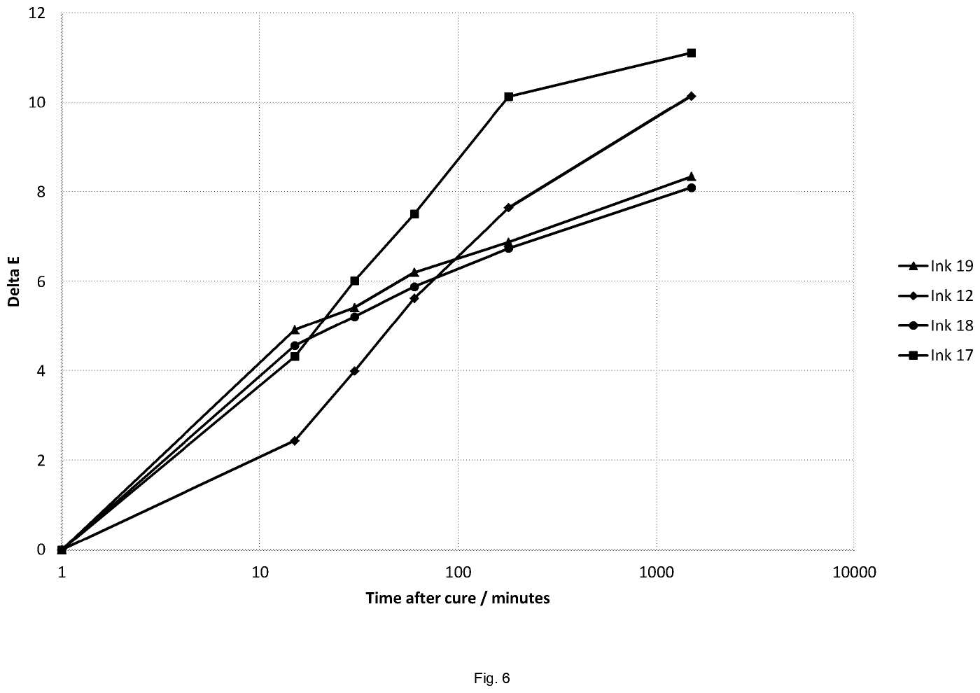

Inks 12 and 17-19 were drawn down onto white self-adhesive PVC using a K bar automatic wire wound coater to achieve a controlled wet film of 12 microns. They were then cured using a Phoseon 20 W LED lamp (395 nm, 800-1000 mJ/cm²) set at 40% power at 20 m/min speed and 2 passes. All inks had adequate surface cure post-cure as described above. Colour shift was then measured on a photospectrometer for L*, a* and b* values over a period of 24 hours and the delta E values found. Again, the principal change in the L*, a* and b* values is on the b* axis in the yellow quadrant and therefore, the delta E values are an indicative measure of Δb*. The results of the colour shift of the inks are set out in Tables 15-18 and FIG. 6 where delta E values for the inks over 24 hours after cure are shown.

TABLE 15

| | | Ink 12 (comparative) | | | |
|---|---|---|---|---|---|
| Interval | Time/minutes | L* | a* | b* | Delta E |
| Initial | 1 | 49.08 | −41.47 | −48.21 | 0.00 |
| 15 mins | 15 | 49.64 | −40.23 | −50.24 | 2.44 |
| 30 mins | 30 | 49.90 | −39.46 | −51.57 | 4.00 |
| 1 hour | 60 | 50.11 | −38.70 | −53.00 | 5.63 |
| 3 hours | 180 | 50.61 | −37.64 | −54.65 | 7.65 |
| 24 hours | 1500 | 50.89 | −36.19 | −56.69 | 10.15 |

The Δb* absolute value over 24 hours for ink 12 was 8.48.

TABLE 16

| | | Ink 17 (comparative) | | | |
|---|---|---|---|---|---|
| Interval | Time/minutes | L* | a* | b* | Delta E |
| Initial | 1 | 49.86 | −44.02 | −45.66 | 0.00 |
| 15 mins | 15 | 50.66 | −42.08 | −49.44 | 4.32 |
| 30 mins | 30 | 51.07 | −41.39 | −50.94 | 6.02 |
| 1 hour | 60 | 51.37 | −40.54 | −52.14 | 7.51 |
| 3 hours | 180 | 51.54 | −38.87 | −54.23 | 10.14 |
| 24 hours | 1500 | 52.27 | −38.89 | −55.22 | 11.11 |

The Δb* absolute value over 24 hours for ink 17 was 9.56.

TABLE 17

| | | Ink 18 | | | |
|---|---|---|---|---|---|
| Interval | Time/minutes | L* | a* | b* | Delta E |
| Initial | 1 | 49.64 | −41.10 | −49.83 | 0.00 |
| 15 mins | 15 | 50.54 | −38.55 | −53.94 | 4.92 |
| 30 mins | 30 | 50.52 | −38.51 | −54.51 | 5.42 |
| 1 hour | 60 | 50.69 | −37.82 | −54.99 | 6.20 |
| 3 hours | 180 | 50.77 | −37.42 | −55.53 | 6.88 |
| 24 hours | 1500 | 50.86 | −36.44 | −56.64 | 8.34 |

The Δb* absolute value over 24 hours for ink 18 was 6.81.

TABLE 18

| | | Ink 19 | | | |
|---|---|---|---|---|---|
| Interval | Time/minutes | L* | a* | b* | Delta E |
| Initial | 1 | 49.25 | −40.10 | −50.48 | 0.00 |
| 15 mins | 15 | 49.97 | −37.70 | −54.30 | 4.57 |
| 30 mins | 30 | 50.18 | −37.49 | −54.90 | 5.22 |
| 1 hour | 60 | 50.18 | −37.08 | −55.45 | 5.89 |
| 3 hours | 180 | 50.48 | −36.68 | −56.16 | 6.74 |
| 24 hours | 1500 | 50.67 | −35.83 | −57.21 | 8.10 |

The Δb* absolute value over 24 hours for ink 19 was 6.73.

As can be seen from FIG. 6, a reduction in colour shift is seen when including MEHQ in an inkjet ink comprising either ITX (ink 18) or DETX (ink 19) and PEA/NVC. In this regard, ink 12 and ink 17, where the ITX has been replaced with DETX, have a much higher colour shift when compared to inks 18 and 19 with MEHQ present.

### Example 5

Various amounts of MEHQ and ITX were also investigated. In this regard, using ink 12, the ITX and MEHQ levels were varied, with the rest of the formulation made up to 100% by adjusting the PEA component of the ink. The formulation for ink 12 is as detailed above. The amount of ITX and MEHQ in each ink is as detailed in Table 19.

The inks were drawn down onto white self-adhesive PVC using a K bar automatic wire wound coater to achieve a controlled wet film of 12 microns. The inks were then cured with multiple passes at 111 mJ using a Phoseon 20 W LED lamp (395 nm) set at 20% power at 40 m/min speed until no ink offset was obtained with the AMRL cure test. The dose required to achieve full cure is listed numerically (mJ/cm²) in Table 19. The inks are graded in terms of colour shift over a 24 hour period.

The underlined cells in the top/right of the table have a maximum colour shift of greater than 10 delta E over 24 hours. The central cells with no underlining have a maximum colour shift of more than 5 delta E but less than 10 delta E over 24 hours. The underlined cells in the bottom two rows of the table have a maximum colour shift of less than 5 delta E over 24 hours.

Inks that required a dose greater than 800 mJ were not assessed as these were not considered viable options (ink 12 cures at 777 mJ and has a maximum delta E during 24 hours of 11 in this test).

TABLE 19

| | ITX LEVEL (%) | | | | |
|---|---|---|---|---|---|
| MEHQ (%) | 0 | 1 | 2 | 3 | 4 |
| 0.0 | Expect <999 | Expect < 555 | Expect < 444 | Expect < 333 | Expect < 222 |
| 0.1 | 999 | 555 | 444 | 333 | 222 |
| 0.5 | 1110 | 555 | 555 | 444 | 222 |
| 1.0 | >3330 | 555 | 555 | 555 | 444 |
| 1.5 | >3330 | 666 | 555 | 666 | 444 |
| 2.0 | >3330 | 777 | 555 | 777 | 555 |

As can be seen from Table 19, preferred amounts were 0.1-5.0% MEHQ with 0.1-5.0% ITX/DETX. More preferably, the amount is 0.1-2.0% MEHQ with 0.5-4.0% ITX/DETX.

The molar ratios of MEHQ to the thioxanthone photoinitiator for the majority of the inks of Table 19 are shown in Table 20.

TABLE 20

| | ITX LEVEL (%) | | | | |
|---|---|---|---|---|---|
| MEHQ (%) | 0 | 1 | 2 | 3 | 4 |
| 0.0 | — | — | — | — | — |
| 0.1 | — | 0.2:1 | 0.1:1 | 0.07:1 | 0.05:1 |
| 0.5 | — | 1.0:1 | 0.5:1 | 0.3:1 | 0.3:1 |
| 1.0 | — | 2.1:1 | 1.0:1 | 0.7:1 | 0.5:1 |
| 1.5 | — | 3.1:1 | 1.5:1 | 1.0:1 | 0.8:1 |
| 2.0 | — | 4.1:1 | 2.0:1 | 1.4:1 | 1.0:1 |

As can be seen from Table 20, the preferred molar ratio of MEHQ to the thioxanthone photoinitiator is from 0.5:1 to 10.0:1.

1. An inkjet ink comprising: PEA; NVC or NVMO, wherein NVC or NVMO is present in 10 to 20% by weight, based on the total weight of the ink; 4-methoxyphenol; and a thioxanthone photoinitiator, wherein the ink further comprises 5 to 35% by weight of one or more radiation-curable monomers having two or more functional groups, based on the total weight of the ink, and wherein the molar ratio of 4-methoxyphenol to the thioxanthone photoinitiator is from 0.5:1 to 10.0:1.

2. An inkjet ink as claimed in claim 1, wherein the thioxanthone photoinitiator comprises ITX and/or DETX.

3. An inkjet ink as claimed in claim 2, wherein the thioxanthone photoinitiator comprises ITX.

4. An inkjet ink as claimed in claim 1, wherein the inkjet ink is an LED-curable inkjet ink.

5. An inkjet ink as claimed in claim 1 comprising at least one additional radiation-curable material.

6. An inkjet ink as claimed in claim 5, wherein the additional radiation-curable material is selected from IBOA, CTFA and Medol-10.

7. An inkjet ink as claimed in claim 1, further comprising one or more additional photoinitiators.

8. An inkjet ink as claimed in claim 7, wherein the one or more additional photoinitiators comprises a phosphine oxide photoinitiator, preferably 2,4,6-trimethylbenzoyl-diphenylphosphine oxide (TPO).

9. An inkjet ink as claimed in claim 1, further comprising a colouring agent, preferably a dispersed pigment.

10. An inkjet ink as claimed in claim 9, wherein the colouring agent is cyan.

11. A method of inkjet printing comprising inkjet printing the inkjet ink as claimed in claim 1 onto a substrate and curing the ink by exposing the printed ink to a UV radiation source.

12. A method of inkjet printing as claimed in claim 11, wherein the UV radiation source is a UV LED radiation source.

13. Use of 4-methoxyphenol for reducing colour shift in an inkjet ink.

14. Use of 4-methoxyphenol for reducing colour shift in a LED-curable inkjet ink.
